(19) United States
(12) Patent Application Publication
(10) Pub. No.: US 2007/0110866 A1
(43) Pub. Date: May 17, 2007

(54) Apparatus and method for holding tortilla during cooking

(76) Inventor: Paul J. Rubel, Santa Barbara, CA (US)

Correspondence Address: KOPPEL, PATRICK & HEYBL, 555 ST. CHARLES DRIVE, SUITE 107, THOUSAND OAKS, CA, 91360, US

(21) Appl. No.: 11/600,364

(22) Filed: Nov. 15, 2006

Related U.S. Application Data
(60) Provisional application No. 60/737,200, filed on Nov. 15, 2005.

(51) Int. Cl. A23P 1/00

(52) U.S. Cl. 426/523; 99/426

(57) ABSTRACT

A tortilla cooking apparatus comprising inner pillars arranged to support one or more tortillas in an inverted U-shape and to prevent the tortillas from closing during cooking. Outer pillars are included on the outside of the inner pillars and arranged to prevent the tortillas from opening during cooking. The inner and outer pillars positioned so that a respective one of the U-shape sides of each of the supported tortillas is between one of the inner pillars and one of the outer pillars. A method for cooking a tortilla comprises supporting the tortilla in an inverted U-shape such that the tortilla does not open or close during cooking. A liquid is held near the tortilla. The tortilla and liquid are heated to cook the tortilla and to evaporate the water with the evaporated liquid moisturizing the tortilla during cooking.

This application claims the benefit of U.S. Patent Application Ser. No. 60/737,200 to Rubel, filed on Nov. 15, 2005.

### BACKGROUND OF THE INVENTION

1. Field of the Invention

This invention relates to a cooking apparatus and method for forming tortillas into taco shells by cooking in a conventional oven or microwave oven.

2. Description of Related Art

Tacos are made by placing various types of meats and fillings into a U-shaped tortilla and there are generally two types of tacos. One with a hard shaped tortilla, referred to as a shell, and the other with a soft tortilla. The hard shaped shells are traditionally made by deep frying in oil. With the growing desire to eat more healthy foods, the public has moved away from the fried taco shells to the tacos with a soft tortilla. There remains a desire to have a cooked taco shell, but without the oil.

The pace of today's world is also very fast. The public is demanding everything to be done quicker in order to get more done in a day. To meet this demand microwave cooking is becoming more prevalent, and is generally recognized as a quicker way to cook compared to conventional baking.

U.S. Pat. No. 5,628,245 discloses an apparatus for forming tortillas into baked, oil-free taco shells. The apparatus may also be used to retain the shape of commercially prepared pre-formed fried taco shells during their reheating, and to hold baked or reheated taco shells during their filling and serving. The apparatus has a series of linear, parallel spaced crests in the shape of inverted, round bottomed “V”s, with such dimensions as to make a form corresponding to an inverted, taco shell shape. The crests have a plurality of perforations to allow for a uniform and rapid forming and baking of the tortillas upon the crests.

U.S. Pat. No. 5,487,330 discloses a pan for baking taco shells in an oven and for holding the baked shells while filling and serving. The pan has a plurality of elongate parallel tapered ridges with troughs between the ridges. The inverted shell is placed astride a ridge. As the shell is pushed onto the tapered ridge it is gradually opened up. It is held in this open position during baking and retains this open configuration when turned upright and seated in a trough where it is fully supported during filling and serving. At each end of the trough, a stop element slopes upward from the bottom of the trough. It is high enough to retain any spilled contents in the trough as well as preventing the tacos from sliding off the pan when tilted. The stop element also serves to facilitate grasping of the filled taco from below by gradually lifting up the taco as it is slid along the trough and over the stop element.

U.S Pat. No. 5,400,704 discloses an apparatus and method for cooking a tortilla for use, e.g. as a taco shell, produces an edible wrapper, preferably having a narrow partially cooked flexible strip across the central diameter and a fully cooked firm and crispy texture adjacent the flexible area, that can be folded into the typical taco shell U-shape. Preferably, the tortilla is cooked in a microwave oven using two perforated rigid and reusable microwave energy transparent frame members between which a flat fresh uncooked tortilla is positioned. Selective microwave attenuation by a conductive screen strip means, and controlled expansion and distortion of the tortilla by the frame members provide the double textured food end product with desirable surface bubbling, blistering and delamination.

### SUMMARY OF THE INVENTION

Briefly, and in general terms, the invention is directed to an apparatus and method for holding a tortilla in a U-shaped orientation for cooking in a conventional or microwave oven. One embodiment of a tortilla cooking apparatus according to the present invention comprises inner pillars arranged to support one or more tortillas in an inverted U-shape and to prevent the tortillas from closing during cooking. Outer pillars are included on the outside of the inner pillars and arranged to prevent the tortillas from opening during cooking. The inner and outer pillars positioned so that a respective one of the U-shape sides of each of the supported tortillas is between one of the inner pillars and one of the outer pillars.

One embodiment of a multiple tortilla cooking apparatus according to the present invention comprises a tray and a plurality of pillar sets integral to said tray. Each of the pillar sets is capable of holding a tortilla in an inverted U-shape over the tray during cooking. Each of the pillar sets also prevents its tortilla from opening or closing during cooking.

One embodiment of a method for cooking a tortilla according to the present invention comprises supporting the tortilla in an inverted U-shape such that the tortilla does not open or close during cooking. A liquid is held near the tortilla. The tortilla and liquid are heated to cook the tortilla and to evaporate the water with the evaporated liquid moisturizing the tortilla during cooking.

These and other further features and advantages of the invention will be apparent to those skilled in the art from the following detailed description, taken together with the accompanying drawings.

### BRIEF DESCRIPTION OF THE DRAWINGS

FIG. 1 is a perspective view of one embodiment of a tortilla cooking apparatus according to the present invention;

FIG. 2 is a detailed perspective view of one embodiment of the bottom surface of the tortilla cooking apparatus in FIG. 1;

FIG. 3 is a side view of the tortilla cooking apparatus shown in FIG. 1;

FIG. 4 is a side view of the tortilla cooking apparatus in FIG. 1 with a tortilla prior to mounting in the apparatus;

FIG. 5 is a side view of the tortilla cooking apparatus in FIG. 4 with the tortilla mounted for cooking; and

FIG. 6 is a side view of the tortilla cooking apparatus in FIG. 4 with four tortillas mounted for cooking.

### DETAILED DESCRIPTION OF THE PREFERRED EMBODIMENTS

The present invention provides a cooking apparatus for holding tortillas in an inverted U-shape for cooking and prevents them from closing during cooking. The invention is arranged to function in either an oven or a microwave oven, but is particularly adapted for cooking in a microwave oven. The cooking device generally consists of a base with raised walls around its perimeter which would allow it to hold liquid. Attached to the sides of these raised walls are handles which allow the device to be easily picked up and carried. Mounted to the top surface of the base are several holding racks designed to hold one or more tortillas in an inverted U-shape and to prevent the open end of each of the tortillas from closing.

In one embodiment, the cooking apparatus comprises sets of pillars (or blades) with the rack having four rows of parallel pillars for each tortilla to be held by the apparatus. For example, in an embodiment for holding four tortillas the apparatus contains four sets of four parallel pillars. Each of the rows of pillars is aligned in a direction perpendicular to the axis of the tortilla's U shape. As more fully described below, the inside pillars support and hold the U section of the tortilla and also restricts the open end of the tortilla from closing in on itself during cooking. The outside pillars prevent the tortilla from expanding into an open U shape or allowing the ends to curl outward. The width and length of the pillars may vary based on the number of pillars per rack and the size of the tortillas. Numerous sets of the four pillars could be used to reduce the amount of material required to fabricate the device and also allow for more open area below the shaped tortilla. The pillar sets can be positioned adjacent to each other for holding numerous tortillas in one or more rows for cooking.

Microwave ovens can super heat water and when water is contained in a smooth walled container during microwave heating, the water does not efficiently boil. Adding rough surfaces or microscopic points can initiate bubbles and form a boiled water condition similar to that found in a standard kettle. The water in this traditional boiling state releases more water molecules than from a smooth cup. The present apparatus takes advantage of these microwave characteristics by allowing water to be held in the base during microwave cooking of the tortillas. The surface of the base can be roughened or can contain other features to allow for bubbles to be formed in the water. The tortillas are held by the cooking apparatus in an inverted U-shape over the water during cooking, which allows the tortillas to be moisturized to create a more desirable texture.

The present invention is described herein with reference to certain embodiments but it is understood that the invention can be embodied in many different forms and should not be construed as limited to the embodiments set forth herein. It is also understood that when an element or component is referred to as being “on”, “integral to” or another element or component, it can be directly on or integral to the other element or component, or intervening elements may also be present. Furthermore, relative terms such as “inner”, “outer”, “above”, “beneath”, and “below”, and similar terms, may be used herein to describe a relationship of one component or element to another. It is understood that these terms are intended to encompass different orientations of the device in addition to the orientation depicted in the figures.

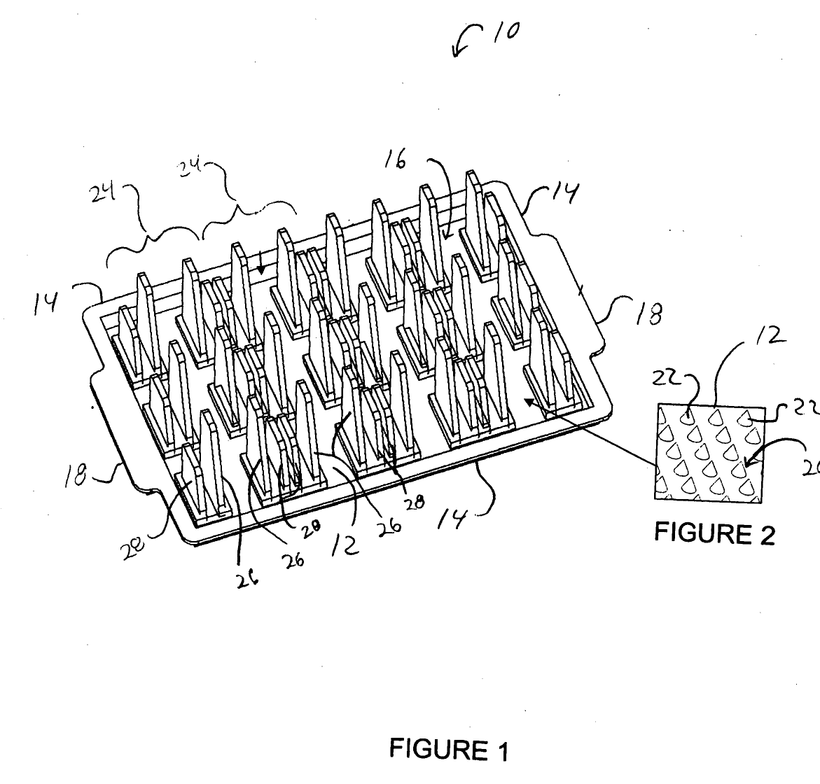

FIG. 1 shows one embodiment of a tortilla cooking apparatus 10 according to the present invention comprising a base 12 with raised vertical walls 14 around the edge of the base. The base 12 and walls 14 form a trough 16 for holding liquid during cooking. Two of the opposing walls have handles 18 for grasping when handling the apparatus 10.

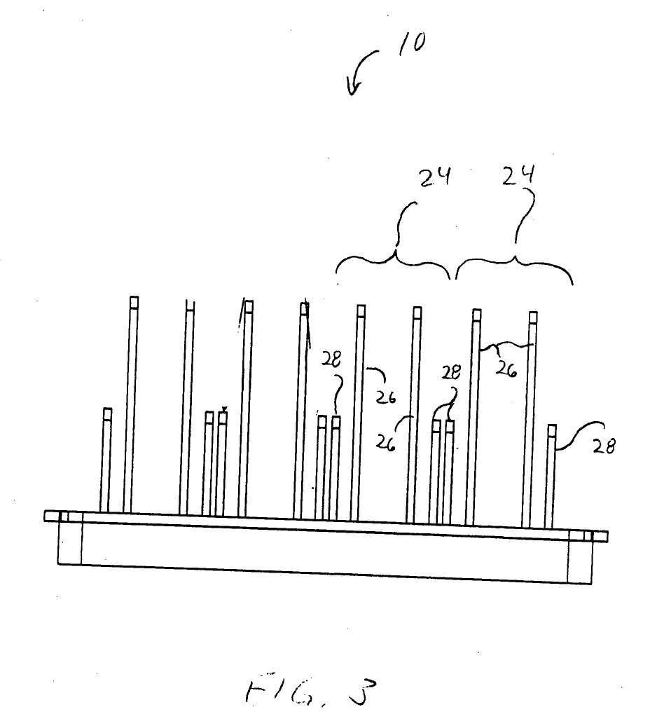

Referring now to FIG. 2, a more detailed portion of the top surface of the base 12 is shown and in some embodiments it can be smooth. In other embodiments and as shown in FIG. 2, it can comprise a roughened surface 20 to facilitate the formation of bubbles in the trough liquid during microwave cooking. The roughening can comprise random features, or as shown, organized features 22, both of which can be formed using known techniques.

Referring again to FIG. 1, along with FIG. 3, the apparatus 10 contains pillar sets 24, with each set arranged to hold a respective tortilla during cooking. The apparatus 10 as shown has four pillar sets 24 although other embodiments can have more or less pillar sets depending on the number of tortillas to be handled by the apparatus 10. Each of the pillar sets 24 comprises two rows of inner pillars 26 and two rows of outer pillars 28. The inner pillars 26 provide the primary support for holding the respective tortilla in its U-shaped orientation, with the tortilla folded over the inner pillars 26 as further described below. Each side of the tortilla is arranged between one of the inner pillars 26 and one of the outer pillars 28, with the inner pillars 26 preventing the tortilla from closing during cooking and the outer pillars 28 preventing the tortilla from opening during cooking.

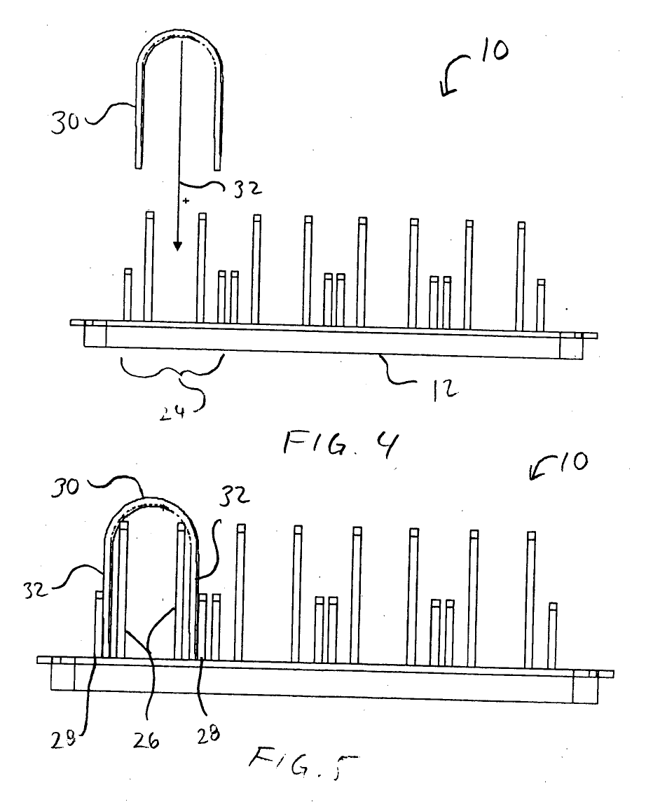

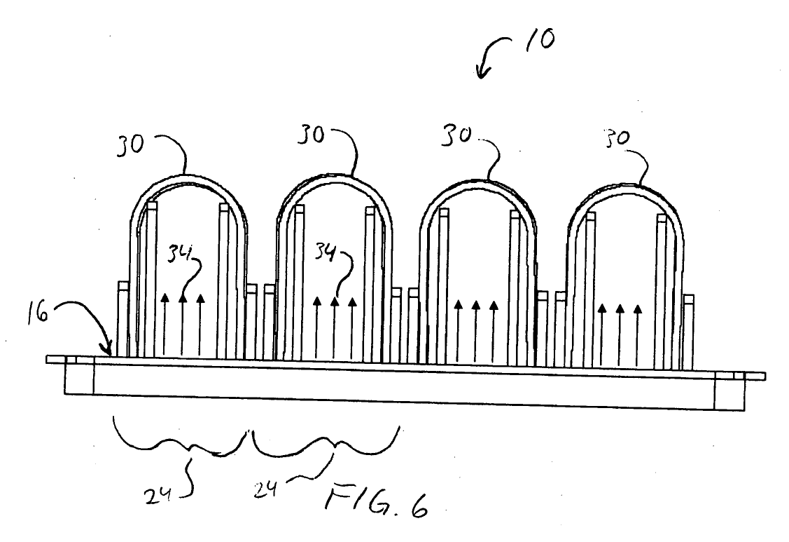

FIGS. 4-6 show the apparatus 10 during use. Referring to FIG. 4, a tortilla 30 is arranged over a pillar set 24 and is bent in a U-shape. The tortilla is then mounted over the pillar set 24 as shown by arrow 32. Referring now to FIG. 5, each of the two sides of the tortilla 32 are mounted between a respective one of the inner pillars 26 and a respective one of the outer pillars 28 to prevent opening and closing of the tortilla 30 during cooking. The inner pillars 26 are longer than the outer pillars 28 and are long enough to hold the tortilla 30 above the tray base 12 so that the tortilla does not interfere with the base 12 and the tortilla 30 is held above liquid held in the base 12. Additional tortillas can be mounted over the remaining pillar sets 24 or the apparatus 10 can be used to cook less than four tortillas. Referring now to FIG. 6, the apparatus 10 is shown with four tortillas 30, each of which is mounted over a respective one of the pillar sets 24 as described above. In embodiments where the trough 16 holds liquid during cooking, the conventional cooking heat or microwave power causes water evaporation 34 to moisturize the tortillas 30 during cooking.

The apparatus 10 can be made of many different materials such as plastics or metal, with a preferred material being a rugged plastic that can withstand elevated temperatures. The apparatus 10 can be fabricated using many known methods, with a preferred method being injection molding. The apparatus can be injection molded as one device or portions of the apparatus can be injection molded separately and then mounted together, such as by bonding or gluing. The features of the apparatus can be arranged in many different ways. For example, the rows of pillars can comprise a single elongated pillar extending across the base, and the apparatus can be arranged without a trough.

In operation pursuant to one embodiment of a cooking method according invention, the tortillas are placed in the inverted U-shape over the inner pillars 26 as described above with sides of the tortilla prevented from closing or opening by the inner and outer pillars 26, 28. The tortillas are held over the tray that can contain a liquid. The tray with the tortillas is then placed in a microwave or convention oven for cooking the soft tortilla to a hard shell. During this cooking step, the liquid in the tray evaporates to moisturize the tortillas so that they do not become too hard of do not become too dry during the cooking.

It will be apparent from the foregoing that while particular forms of the invention have been illustrated and described, various modifications can be made without departing from the spirit and scope of the invention. Accordingly, it is not intended that the invention be limited by the embodiments described herein.

I claim:

1. A tortilla cooking apparatus, comprising:
inner pillars arranged to support one or more tortillas in an inverted U-shape and to prevent said tortillas from closing during cooking; and
outer pillars on the outside of said inner pillars and arranged to prevent said tortillas from opening during cooking, said inner and outer pillars positioned so that a respective one of the two U-shaped sides of each of said supported tortillas is between one of said inner pillars and one of said outer pillars.

2. The apparatus of claim 1, further comprising a tray, said inner and outer pillars integral to said tray.

3. The apparatus of claim 1, wherein said tray further comprises vertical walls such that said tray forms a trough, said tray capable of holding a liquid.

4. The apparatus of claim 3, wherein surfaces of said tray or said vertical walls are roughened to assist boiling of a liquid held in said tray.

5. The apparatus of claim 3, wherein surfaces of said tray or said vertical walls have microscopic points to assist boiling of a liquid held in said tray.

6. The apparatus of claim 1, wherein said inner pillars are longer than said outer pillars.

7. The apparatus of claim 2, wherein said inner pillars have a length that can support said tortilla in said inverted U-shape without said tortilla being interfering with said tray.

8. The apparatus of claim 2, wherein said tray has a handle.

9. A method for cooking a tortilla, comprising:
supporting said tortilla in an inverted U-shape such that said tortilla does not open or close during cooking;
holding a liquid near said tortilla;
heating said tortilla and liquid to cook said tortilla and to evaporate said water, said evaporated liquid moisturizing said tortilla during cooking.

10. The method of claim 9, wherein said tortilla is held in an inverted U-shape by inner pillars, said inner pillars also preventing said tortilla from closing during cooking.

11. The method of claim 9, wherein said tortilla is prevented from opening by outer pillars.

12. The method of claim 9, wherein said liquid is held in tray, said tortilla supported in an inverted U-shape over said tray.

13. The method of claim 12, wherein surfaces of said tray are roughened to assist boiling of a liquid held in said tray.

14. The method of claim 12, wherein surfaces of said tray have microscopic points to assist boiling of a liquid held in said tray.

15. A multiple tortilla cooking apparatus, comprising:
a tray;
a plurality of pillar sets integral to said tray, each of which capable of holding a tortilla in an inverted U-shape over said tray during cooking, each of said pillar sets also preventing its tortilla from opening or closing during cooking.

16. The apparatus of claim 14, wherein each of said pillar sets comprises inner pillars arranged to support its one of said tortillas in an inverted U-shape and to prevent said tortillas from closing during cooking and outer pillars on the outside of said inner pillars and arranged to prevent said tortillas from opening during cooking.

17. The apparatus of claim 14, wherein said tray is capable of holding a liquid, surfaces of said tray being roughened to assist boiling of a liquid held in said tray.

18. The apparatus of claim 14, wherein said tray is capable of holding a liquid, surfaces of said tray having microscopic points to assist boiling of a liquid held in said tray.

19. The apparatus of claim 15, wherein said inner pillars are longer than said outer pillars.

20. The apparatus of claim 15, wherein said inner pillars have a length that can support said tortilla in said inverted U-shape without said tortilla being interfering with said tray.
